(19) United States
(12) Patent Application Publication
(10) Pub. No.: US 2014/0170950 A1
(43) Pub. Date: Jun. 19, 2014

(54) System for Controlling Breathing Air in a Closed Space, and Vehicle Provided with Such System

(71) Applicant: Trans Elektro B.V., Waalwijk (NL)

(72) Inventor: Thomas Wilhelmus van Dijk, Waalwijk (NL)

(73) Assignee: Trans Elektro B.V., Waalwijk (NL)

(21) Appl. No.: 14/105,796

(22) Filed: Dec. 13, 2013

(30) Foreign Application Priority Data
Dec. 14, 2012 (DE) 102012112287.3

(51) Int. Cl. B60H 1/00

(52) U.S. Cl. CPC B60H 1/00642
USPC 454/75

(57) ABSTRACT

The present invention relates to a system for regulating the breathable air in a closed space, comprising an air intake opening for taking in ambient air from outside the space, a measuring system for measuring a predetermined condition, a control system for supplying intake ambient air to the space as breathable air via an air filter or closing the air intake opening and supplying breathable air to the space from a reservoir, both subject to the measured condition. The invention also relates to a vehicle provided with such a system.

### BACKGROUND OF THE INVENTION

1. Field of the Invention

The present invention relates to a system for regulating the breathable air in a space such as a portacabin, a cabin on a ship, gantry crane or particularly a cab of a ground working vehicle.

2. Description of Related Art

When working ground or for instance transporting materials such as coal or waste it is possible for toxic substances, usually gases, to be released, breathing of which by the operator present in the cab is undesirable. It is known for this purpose to filter the air supplied to the cab, for instance using filter overpressure systems, wherein a pressure higher than that of the ambient air is created in the cab in order to prevent infiltration of toxic substances via the cab, which is generally not closable in completely airtight manner.

In those cases where insufficient oxygen is present or where the air is assumed to be contaminated such that filtering is not possible, use is made of breathing air systems, i.e. systems wherein breathable air is provided in bottles and is guided to the cab. Such systems are for instance marketed commercially by SEKA.

A drawback of such systems is that they can only be used for a limited successive period of time since the quantity of breathable air which can be stored is limited. These systems are also time-consuming in use, and therefore also expensive, due to the necessity of replacing or filling the air bottles.

It is an object of the present invention to obviate the above stated drawbacks of the prior art or to provide a worthwhile alternative.

### SUMMARY OF THE INVENTION

The invention provides for this purpose a system for regulating the breathable air in a closed space, particularly of a cab of a vehicle or vessel, comprising an air intake opening for taking in ambient air from outside the space, a measuring system for measuring a predetermined condition and a control system for supplying intake ambient air to the space as breathable air via an air filter or closing the air intake opening and supplying breathable air to the space from a reservoir, both subject to the measured condition.

Breathable air is understood here to mean a mixture suitable for inhaling, which is thus not limited to oxygen. The system according to the invention provides the advantage that the safety of an operator present in the space is ensured in that it closes the air intake opening as soon as a predetermined condition is met, while the control system ensures that sufficient breathable air is always present in such a case. Also achieved in this way is that breathable air from the reservoir is not used before the measured conditions make it necessary to do so. The reservoir can be an oxygen bottle or an assembly of several oxygen bottles, wherein these can be activated separately or connected in parallel

The predetermined conditions can relate directly or indirectly to toxic constituents in the ambient air and/or the measured value of the oxygen level in the air, and the conditions can particularly be a (directly) measured value of the indrawn air such as a toxicity, a geographical value such as reaching or approaching a location known to have (an increased risk of) toxic air, or an ambient condition such as a temperature or light intensity. These latter measurements can for instance be related to driving in a tunnel, pit, cellar, ship's hold, closed space or otherwise less ventilated space, or to reaching a temperature above which determined substances are released. The measurement and/or detection possibly takes place by means of control commands given by the operator, such as switching of a (light) switch.

Usable detectors for determined embodiments are a proximity switch (when approaching a dangerous area) and a position determination switch (beyond a determined point, or in a determined area known to be heavily polluted). This latter variant can be coupled to or provided with a GPS position determining system or navigation system.

For a direct determination of toxicity in the air the control system can for instance comprise a sensor from the group of an O2 sensor, a VOC sensor, a CO sensor or an ammonia sensor. The control system can also be configured to detect concentrations of substances which cannot be filtered (for instance CO) but also of excessively high concentrations of substances which can be filtered (for instance benzene), or excessively high or low values of oxygen.

In order to prevent infiltration of toxic substances via openings in the space the system can also be configured to supply breathable air to the space under overpressure relative to the pressure of the ambient air, in particular an overpressure of more than 50 Pa, preferably more than 75 Pa, and in particular around 100 Pa.

The air filter can comprise a passive filter, although an active carbon filter is preferably applied which is configured to filter one or more constituents from the group of:

A Organic gases and solvents (petrol, PAHs, aromatics);

B Inorganic gases and halogens (chlorine, hydrogen sulphide, cyanides);

E Inorganic vapours and acidic gases (sulphur oxides, hydrochloric acid);

K Ammonia, composting;

Hg Mercury, renovation, gas extraction;

ABEK in accordance with EN14387.

The filter overpressure system can be supplied with a so-called P1 dust filter which can be employed for daily use other than for a clean-up operation. P2 filters are then applied to filter harmful fine dust and P3 filters to block, among others, toxic fine dust such as asbestos particles and quartz dust.

In a particularly advanced embodiment the system is configured to influence the airflow (speed or flow rate) through the filter. The bonding time of contaminated substances to the carbon does after all determine the ratio of separation, which varies per substance. The contact time, and thereby the efficiency of the filter, can be influenced by influencing the airflow.

In a further embodiment the control system is also configured to close the air intake opening when the intake air comprises more than a predetermined value of a substance which can be filtered or when the filtered air comprises more than a predetermined value of a substance which cannot be filtered. An example is too high a concentration of substances which cannot be filtered or too high a concentration of substances which can be filtered, resulting in the risk of saturation of the filter whereby the substance passes though the filter unfiltered

In a preferred embodiment the control system is configured to continue measuring the toxicity of the ambient air when the air intake opening is closed and to open the air intake opening and supply breathable air to the space via the air filter and to stop the supply of air from the reservoir to the space, both subject to the measured toxicity. Use being made longer than necessary of breathable air from the reservoir is in this way prevented. The system hereby becomes economical in use. In a further embodiment the system is provided with a warning device for making measured toxicity known to an operator. The system can also be provided with a dead man's button to which an alarm system is coupled.

The invention also relates to a vehicle or vessel provided with a system as described above.

### BRIEF DESCRIPTION OF THE DRAWINGS

The invention will be further elucidated with reference to the following figures, in which:

FIG. 1 shows a schematic view of a vehicle provided with a system according to the present invention, and

FIG. 2, shows a flow chart of the operation of the system according to the present invention.

### DESCRIPTION OF THE INVENTION

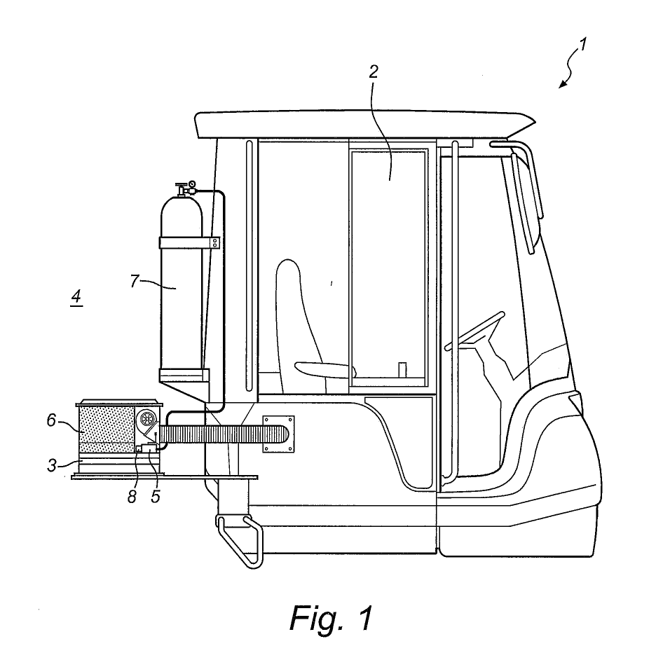

FIG. 1 shows a schematic view 1 of a system for regulating the breathable air in a cab 2 of a ground working vehicle, comprising an air intake opening 3 for intake of ambient air 4 from outside cab 2, a measuring system (not shown) for measuring a predetermined condition and a control system 8 with a monitoring system 8a in the cab for the purpose of supplying intake ambient air to cab 2 as breathable air via an air filte 6 and closing the air intake opening 3 and supplying breathable air from a reservoir 7 to cab 2, both subject to the measured condition. Control system 5 comprises for this purpose a controllable switch 5 with which the breathable air is supplied via filter 6 to the cab.

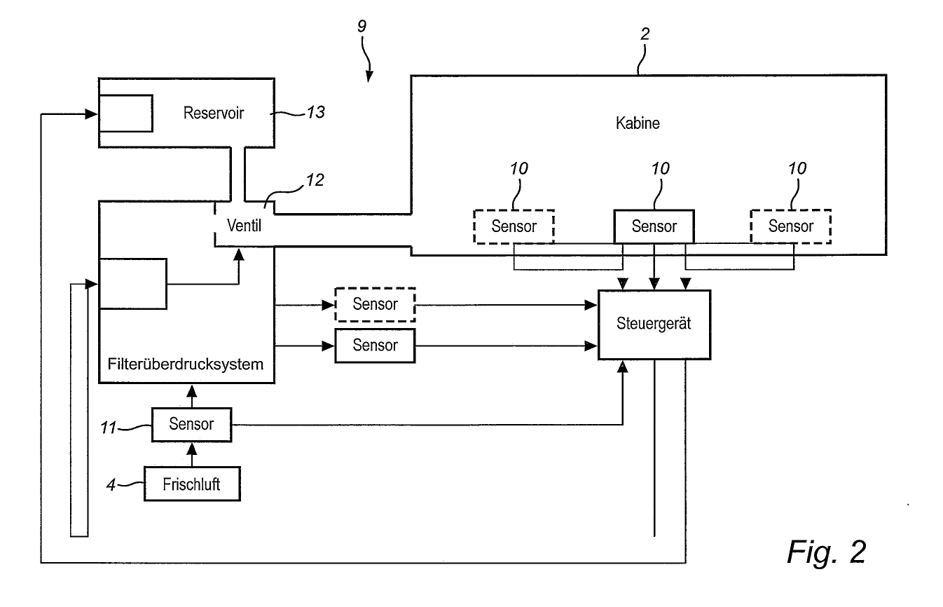

FIG. 2 shows a flow chart 9 of the operation of the system according to the present invention. Shown is that the control device controls the filter device and the air supply from reservoir 13 on the basis of signals generated by sensors 10 inside and 11 outside cab 2. The supply of air from outside cab 2 can be shut off by means of operating a valve 12 and air from the reservoir can be supplied via the filter to cab 2.

In addition to the shown embodiments, many variants can be envisaged with filter types and/or sensors not referred to or wherein the control system is configured to supply to the cab a mixture of filtered breathable air and air from the reservoir. These variants are all deemed to fall within the scope of protection of the following claims.

1. A system for regulating the breathable air in a closed space, particularly a cab, comprising:
an air intake opening for taking in ambient air from outside the space;
a measuring system for measuring a predetermined condition;
a control system for
supplying intake ambient air to the space as breathable air via an air filter, or
closing the air intake opening and supplying breathable air to the space from a reservoir,
both subject to the measured condition.

2. The system as claimed in claim 1, wherein the predetermined condition is a condition from the group of:
a measured value of the indrawn air such as a toxicity;
a geographical value such as reaching or approaching a location;
an ambient condition such as a temperature or light intensity.

3. The system as claimed in claim 1, wherein the control system comprises a sensor, such as a gas detection sensor, from the group of:
O2 sensor;
VOC sensor;
CO sensor;
ammonia sensor.

4. The system as claimed in claim 1, configured to supply breathable air to the space under overpressure relative to the pressure of the ambient air, in particular an overpressure of more than 50 Pa, preferably more than 75 Pa, and in particular around 100 Pa.

5. The system as claimed in claim 1, wherein the air filter comprises an active carbon filter configured to filter one or more constituents from the group of:
A Organic gases and solvents (petrol, PAHS, aromatics);
B Inorganic gases and halogens (chlorine, hydrogen sulphide, cyanides);
E Inorganic vapours and acidic gases (sulphur oxides, hydrochloric acid);
K Ammonia, composting;
Hg Mercury, renovation, gas extraction;
ABEK in accordance with EN14387

6. The system as claimed in claim 1, wherein the control system is configured to close the air intake opening when the intake air comprises more than a predetermined value of a substance which can be filtered or when the filtered air comprises more than a predetermined value of a substance which cannot be filtered.

7. The system as claimed in claim 1, wherein the control system is configured to continue measuring the toxicity of the ambient air when the air intake opening is closed, and
to open the air intake opening and supply breathable air to the space via the air filter; and
to stop the supply of air from the reservoir to the space, both subject to the measured toxicity.

8. The system as claimed in claim 1, configured to influence the airflow (speed or flow rate) through the filter.

9. A vehicle or vessel provided with a system as claimed in claim 1.
